(19) United States
(12) Patent Application Publication
(10) Pub. No.: US 2009/0321656 A1
(43) Pub. Date: Dec. 31, 2009

(54) VERIFYING THE ENERGY OF A PARTICLE BEAM

(76) Inventors: Eike Rietzel, Darmstadt (DE); Nils Tober, Berlin (DE)

Correspondence Address: BRINKS HOFER GILSON & LIONE, P.O. BOX 10395, CHICAGO, IL, 60610, US

(21) Appl. No.: 12/489,949

(22) Filed: Jun. 23, 2009

(30) Foreign Application Priority Data
Jun. 27, 2008 (DE) DE102008030699.1

(51) Int. Cl. G01T 1/29; H01J 1/50

(52) U.S. Cl. 250/397; 250/396 ML

(57) ABSTRACT

A method for verifying the energy of a particle beam is provided. The method includes accelerating charged particles to a predefined energy in an acceleration apparatus, forming a particle beam from the acceleration apparatus and guiding the particle beam by means of a transport apparatus, deflecting the particle beam using at least one magnet, measuring a position of the particle beam in a direction, which is ideally but not necessarily perpendicular to the beam direction, and verifying an actual energy of the particle beam using the measured position.

The present patent document claim the benefit of and filing date of DE 10 2008 030 699.1, filed on Jun. 27, 2008, which is hereby incorporated by reference.

### BACKGROUND

The present embodiments relate to verifying the energy of a particle beam.

Particle therapy is a method for treating tissue, such as tumors. Irradiation methods, as used in particle therapy, are also used in non-therapeutic fields. The non-therapeutic fields include, for example, research work in the context of particle therapy, which is carried out on non-living phantoms or bodies, or irradiation of materials. Charged particles, such as protons or carbon ions or other types of ion for example, are accelerated to high energies, formed into a particle beam and guided by a high-energy beam transport system to one or more irradiation rooms. The object to be irradiated is irradiated with the particle beam in one of the irradiation rooms.

The success of an irradiation operation depends on the system being operated without error. Accordingly, the correct operation of the system may be verified in the context of regular quality assurance (QA) or QA measures. It is verified whether a particle beam, which is requested with certain specifications, actually has the required specifications.

One characteristic of the particle beam that has to be set correctly is the energy of the particle beam because the energy of the particles determines the depth of penetration of the particle beam into an object to be irradiated.

A “water column” or “water phantom” may be used for verifying the energy of the particle beam. An ionization chamber is disposed in the water phantom or water column with the particle beam being directed onto the ionization chamber. This ionization chamber is moved in the beam direction in the water and delivers different measured values. The maximum measured value for depth correlates to the range of the particles. This method is used, for example, for QA measures. The measurements for energy or the determination of a Bragg peak, however, take(s) approximately 3 to 5 minutes per energy, possibly a little less. In the context of a clinical constancy check, a wide energy range is verified. It is also necessary to add the setting up times for the measuring apparatus.

A “multi-layer Faraday cup” has been used in some instances for passive beam applications, in other words when widening the particle beam by a scatter body. A number of Faraday collectors (“Faraday cups”) positioned one behind the other are used to measure the ionization respectively at different depths in order to determine the range of the widened particle beam approximately.

### SUMMARY AND DESCRIPTION

The present embodiments may obviate one or more of the limitations or drawbacks inherent in the related art. For example, in one embodiment, a method for verifying the energy of a particle beam can be operated without setting up a complex measuring apparatus and which can be implemented quickly. In another example, an apparatus for energy verification and a system for accelerating charged particles may be provided. The apparatus and/or system may be used to verify the energy of a particle beam quickly without complex set up operations.

In one embodiment, a method for verifying the energy of a particle beam in a particle therapy system is provided. The method includes accelerating charged particles to a predefined energy in an acceleration apparatus of the particle therapy system, extracting (forming) a particle beam from the acceleration apparatus, for example, using the charged particles, and guiding the particle beam to an irradiation room of the particle therapy system by means of a transport apparatus, deflecting the particle beam using at least one deflection magnet, measuring a position of the particle beam in a direction having a component perpendicular to the beam direction, and verifying an actual energy of the particle beam using the measured position.

A diversion of the particle beam in a magnetic field is a function of energy. The Lorentz force, which causes a charged particle to be diverted in the magnetic field, is a function of the magnetic field and the speed of the particle. If the energy of the particle beam and the magnetic field are known, a setpoint position of the particle beam may be determined at any measuring point along the beam direction. However, when the measured position of the particle beam differs from the setpoint position in the measuring point, the actual energy of the particle beam may not correspond to the predefined energy. The predefined energy may correspond to an energy, which allows the irradiation of a target object, for example, a patient or phantom, to take place for research or calibration purposes.

The measured position and setpoint position differ because the particle beam deviates from a setpoint travel direction. The deviation can be measured in a direction that is not parallel to the beam travel direction, which has a component. The component may be disposed perpendicular to the travel direction. The direction may be disposed essentially perpendicular to the beam direction, i.e. in an angle range of 90°±15°, 90°±10°, 90°±5° or even less. However this is not necessarily the case. The direction may be disposed at an acute or obtuse angle to the beam travel direction, which deviates more than 15° from the beam direction. The more the angle deviates from the perpendicular, the more complex it is to configure a measuring apparatus so that even small deviations of the beam travel from the setpoint travel direction can be detected.

The method for verifying the energy of the particle beam can be used in a system. Particles are accelerated and guided by the transport apparatus into an irradiation room, for example, in a particle therapy system.

The actual energy of the particle beam is verified for a deviation with respect to the predefined energy of the particle beam.

Compared with methods in which the energy is verified by determining the position of the Bragg peak in a water column or water phantom, the method is significantly faster and simpler.

It can be verified whether the particle beam actually has the desired, predefined energy, for example, by calculating the actual energy of the particle beam from the position of the particle beam. This is possible because the speed of the particles may be determined from the position of the particle beam and because the magnetic field strength of the deflection magnet, or the magnetic field strengths of the deflection magnets, where a number of deflection magnets are used, and the geometric profile of the particle beam are known. Physical relationships, such as the Lorentz force, and the energy/pulse relationship in a moving particle are used for calculation purposes. The magnetic field strength of the deflection magnet or deflection magnets and the correct setting may be verified or ensured, for example, by a magnetic field measurement and/or field strength regulation. The position is measured at a point after the point where the particle beam was deflected, when viewed in the beam direction.

The quantitative determination may determine the absolute energy of the particle beam or the relative energy difference compared with the preset energy or the relative energy difference between two preset energies. The calculation does not have to allow the exact actual energy of the particle beam. Depending on the desired accuracy, it may be adequate just to calculate the energy approximately. The relationship between the location of the particle beam and the actual energy of the particle beam can also be stored in a computer unit, for example, in a table. A specific calculation based on a formula may not be required.

The verification does not have to be associated with a quantitative determination of the energy of the particle beam. It is possible to carry out a qualitative verification. For example, a signal may be generated when the measured position of the particle beam deviates from an expected position too much, for example, when the deviation is above a threshold value. As a result, it is determined by the position measurement that the actual energy of the particle beam deviates too much from the predefined energy. This can be the trigger for system maintenance, for example.

The method may be implemented and automated quickly and simply. The method does not require the complex setting up of measuring apparatus provided specifically for the purpose and can generally be carried out within a few seconds.

The method may be combined with other methods, which are used to verify the energy of the particle beam. For example, a more complex method, which measures the energy very accurately, for example measuring the energy of the particle beam using a test specimen, such as a water phantom, for example, can be implemented at specific maintenance intervals. The method may be deployed between these maintenance intervals to verify the energy of the particle beam more frequently.

In one embodiment, the particle beam is aligned isocentrically. As used herein, the term “aligned isocentrically” includes, using any control or scan magnets can be set in the transport direction, so that the particle beam strikes the isocenter in an irradiation room, as long as the actual energy of the particle beam corresponds to the desired, predefined energy. In a particle therapy system such a setting can be achieved particularly simply, as such a system is generally designed so that the particle beam strikes the isocenter without further deflection by scan magnets.

In one embodiment, the particle beam is controlled in such a manner that the particle beam is diverted successively to different, preset degrees, with the position of the particle beam being measured a number of times and with the actual energy of the particle beam being verified using the measured positions. It is possible to use the relative position of the measured positions to determine the energy of the particle beam.

Accordingly, it is possible to configure the method particularly accurately. Because a pattern of points is approached by the particle beam, a number of measuring points are measured at different positions. The actual position and/or arrangement of the measuring points provide information about the energy of the beam. The energy of the beam may be determined in a redundant manner, for example, thereby increasing the reliability of the method. The relative position of the points in relation to one another in particular permits a simpler conclusion about the energy of the beam, as it is no longer necessary to determine the absolute position of a measuring point in the room, which is more complex.

In one embodiment, it is possible, for example, to irradiate a regular pattern with defined distances between the positions, such as the corners of a square. If the energy of the particle beam corresponds to the expected or scheduled energy, the distances between the points are measured as expected. If there are deviations in the particle energy supplied, the distances between the corners are shortened or lengthened accordingly.

If the particle beam is diverted successively to different degrees, it can be more readily concluded (determined) whether a deviation is due to an incorrect energy setting or incorrect beam guidance. If the particle beam is deflected twice, for example, with a scan magnet and in a counter direction to a zero position, in the case of an incorrect energy setting the deviation in both directions from the setpoint positions is approximately equal. The deviations correlate approximately to one another. If the deviations in both directions from the setpoint positions are different, this is instead because the settings for a scan magnet for example are incorrect or the beam is not guided correctly, so that the beam does not enter the deflection magnet at the expected point. The deviations then do not correlate to one another.

In one embodiment, the particles in a system are accelerated. The particle beam is guided by the transport apparatus into an irradiation room and exits from an exit window. To measure position, a first measuring apparatus is used, which is disposed after the exit window in the beam direction. The measuring apparatus can be positioned in the isocenter, for example.

In another embodiment, a second measuring apparatus is used for position measurement, being disposed between the deflection magnet and the exit window. The second measuring apparatus may be provided, for example, in particle therapy systems to verify the position of the particle beam. The measuring apparatus is disposed, for example, in the so-called BAMS (beam application and monitoring system) at the end of the transport apparatus and during regular operation of the system serves to measure and check the position of the particle beam when carrying out an irradiation. No additional measuring apparatus is then required to implement the method, measuring apparatus that is already present being used.

The measuring apparatus may be a wire or strip chamber, for example, a multi-wire proportional chamber (MWPC), for location measurement.

If the system is configured in such a manner that it has at least one control element for diversion of the particle beam, for example, a scan magnet, the second measuring apparatus may be used for a control mechanism for location correction of the particle beam. The location of the particle beam is measured in this process, compared with a setpoint position and the control element is set correspondingly so that the setpoint position is achieved even with a deviation. However, when the method is being implemented, the system is operated in such a manner that the control mechanism for location correction is deactivated. The deviation of the position of the particle beam from a setpoint position is used specifically to verify the energy of the particle beam and should not be corrected automatically. Another embodiment is described in more detail below.

The energy verification apparatus may verify the energy of a particle beam, which is accelerated to a predefined energy and is guided by a transport apparatus and deflected from a straight travel direction. The energy verification apparatus may include a measuring apparatus for measuring a position of the particle beam in a direction, which has a component perpendicular to the beam direction, an evaluation apparatus for verifying an actual energy of the particle beam using the position measured by the measuring apparatus.

In one embodiment, a particle therapy system comprises: an acceleration apparatus for accelerating charged particles to a predefined energy, a transport apparatus for guiding the accelerated particle beam to an irradiation room by means of a transport apparatus, a magnet for deflecting the particle beam, and an energy verification apparatus for energy verification with a measuring apparatus for measuring a position of the particle beam in a direction, which has a component perpendicular to the beam direction, and with an evaluation apparatus for verifying an actual energy of the particle beam using the position measured by the measuring apparatus.

The energy verification apparatus for verifying the energy of the particle beam or the particle therapy system with such an apparatus can be configured in such a manner that the different embodiments of the method can be carried out with the apparatus for energy verification or with the particle therapy system.

### BRIEF DESCRIPTION OF THE DRAWINGS

Embodiments of the invention and developments according to the features of the dependent claims are described in more detail with reference to the following drawing without being restricted thereto. In the drawing:

FIG. 1 shows one embodiment of a particle therapy system,

FIG. 2 shows one embodiment of an isocentrically deflected particle beam,

FIG. 3 shows one embodiment of a particle beam that is diverted a number of times in a different manner with scan magnets,

FIG. 4 shows one embodiment of a feedback control loop for location correction of the particle beam that is deactivated, and

FIG. 5 shows one embodiment of a method.

### DETAILED DESCRIPTION

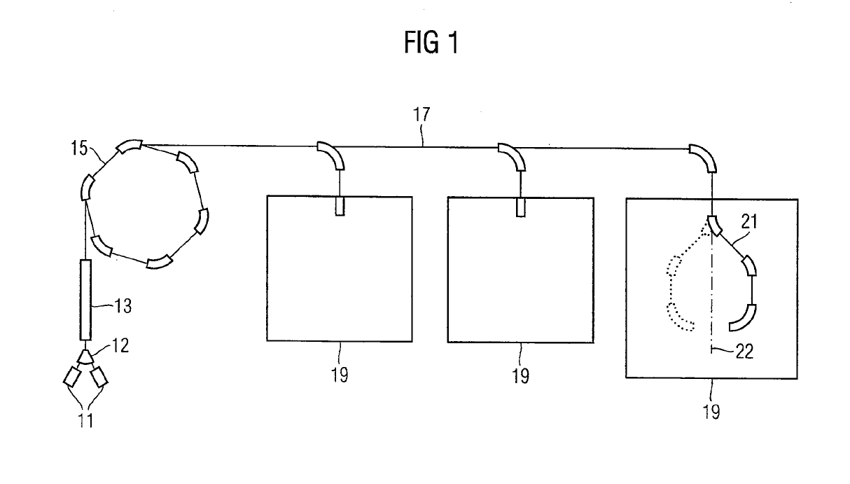

FIG. 1 shows a particle therapy system 10. The particle therapy system 10 may be used to irradiate, for example, using a particle beam, a body, such as tumorous tissue.

The particles may be ions, such as protons, pions, helium ions, carbon ions or other types of ions, for example. The particles may be generated in a particle source 11. As shown in FIG. 1, two particle sources 11 may be used to generate two different types of ion. Accordingly, it is possible to switch between these two types of ion within a short time interval. A solenoid switch 12, for example, is used for switching. The solenoid switch 12 may be disposed between the ion sources 11 and a pre-accelerator 13. This allows the particle therapy system 10 to be operated, for example, with protons and carbon ions at the same time.

The ions generated by the or one of the ion sources 11 and optionally selected using the solenoid switch 12 are accelerated in the pre-accelerator 13 to a first energy level. The pre-accelerator 13 is, for example, a LINear ACcelerator (LINAC). The particles are then fed into an accelerator 15, for example, a synchrotron or cyclotron. In the accelerator 15, the particles are accelerated to high energies, as required for irradiation. When the particles leave the accelerator 15, a high-energy beam transport system 17 guides the particle beam to one or more irradiation rooms 19. In an irradiation room 19 the accelerated particles are directed onto a body to be irradiated. Depending on the embodiment, the particles may be directed from a fixed direction (in a “fixed beam” room) or from different directions by a gantry 21 that can be moved about an axis 22.

The structure of the particle therapy system 10 illustrated in FIG. 1 is an example of a particle therapy system but it may also differ from this.

The exemplary embodiments described below can be used both in conjunction with the particle therapy system illustrated with reference to FIG. 1 and also with other particle therapy systems or in systems in which particles are accelerated and in which the energy of the accelerated particles is to be verified.

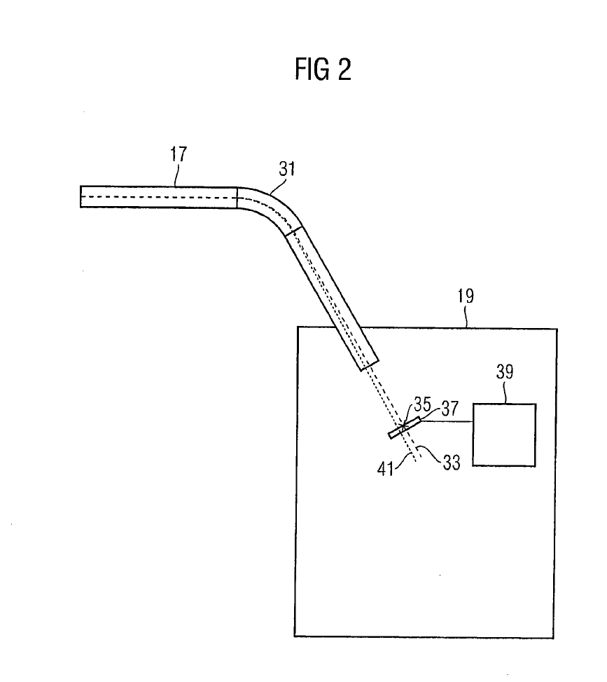

FIG. 2 shows a particle beam being guided by the high-energy beam transport system 17 into an irradiation room 19 and being diverted by a deflection magnet 31. At the end of the high-energy beam transport system 17, the particle beam exits from an exit window 43. The particle beam is aligned isocentrically. In other words, the predefined energy of the particle beam and the magnetic strength of the deflection magnet 31 (and optionally settings of further elements in the high-energy beam transport system 17) are selected in such a manner that the particle beam strikes the isocenter 35 of the irradiation room 19, for example, when the operating parameters are correctly set. A particle beam, for which all the operating parameters are set correctly, for which the actual energy corresponds to the predefined desired energy, is shown with a broken line 33.

A location detector 37 may be disposed at the isocenter 35 and may be used to detect the position of the particle beam in a direction perpendicular to the travel direction of the particle beam. The location detector 37 may be a multi-wire proportional chamber. The multi-wire proportional chamber allows the generation of an electronic signal, which is characteristic of the location of the particle beam and can be evaluated in a simple manner in a downstream computer unit 39. The actual energy of the particle beam may be verified in the computer unit 39.

If, for example, the measured location of the particle beam deviates from the isocenter 35, it may be determined that the actual energy of the particle beam does not correspond to the predefined energy of the particle beam. This is shown in FIG. 2 with reference to the particle beam shown with a dotted line 41. The particle beam is diverted by the deflection magnet 31 and does not strike the isocenter 35. By measuring, the location detector 37 may ascertain that the particle beam has an actual energy, which is less than the predefined, desired energy.

The verification may be qualitative or quantitative, as the deviation of the particle beam from the isocenter increases, the more the actual energy of the particle beam deviates from the predefined energy of the particle beam.

Deflection of the particle beam may be effected by a deflection magnet 31, as shown in FIG. 2, for example.

Deflection of the particle beam may be provided, for example, by scan magnets. Scan magnets may be used to divert the particle beam from a main axis, in order to be “scanned” over a target volume. The magnetic field generated by scan magnets may be smaller than the magnetic field generated by deflection magnets, which conduct the particle beam into a specific irradiation room. The location of the particle beam is measured more precisely when the deflection of the particle beam is only effected by the comparatively weak magnetic field of the scan magnets.

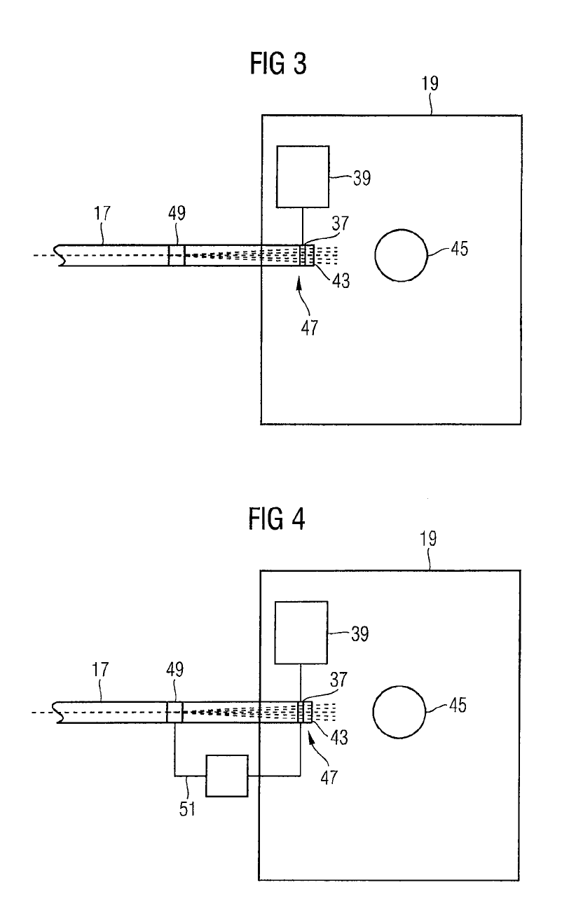

FIG. 3 shows a particle beam exiting from the high-energy beam transport system 17 from an exit window 43, to strike the target volume 45 to be irradiated after a short passage through the air.

A beam application apparatus or BAMS 47 (“beam application and monitoring system”) may be disposed before the exit window 43. The BAMS 47 may be used to modify the particle beam once again shortly before the exit and/or which can be used to verify parameters of the particle beam shortly before the exit. Location detectors, such as multi-wire proportional chambers, may be disposed in the BAMS 47. The location detectors may be used to measure the location of the particle beam in a plane perpendicular to the beam travel direction. A location detector 37 may be disposed in the BAMS 47.

A scan magnet 49, which can be used to change the travel direction of the particle beam during the irradiation of a target volume 45 in a certain region, may be located before the BAMS 47 in the beam direction, so that the particle beam is scanned over the target volume 45, for example. In one embodiment, the scan magnet 49 may be activated so that the particle beam travels a predefined pattern, with the particle beam being diverted to different locations one after the other. The position of the particle beam may be measured respectively. It is then possible to conclude (determine) the energy of the particle beam from the relative position of the locations to one another.

If the distance between the individual positions of the particle beam is larger, the energy of the particle beam is less than with a pattern in which the distance between the individual positions is smaller, assuming identical activation of the scan magnet 49. This is because the particle beam is diverted more by the magnetic field of the scan magnet 49 when there is less energy, thereby generating a generally larger pattern.

The relative position of the measured positions to one another can be used to verify the energy of the particle beam. The energy of the particle beam can be measured quantitatively or even just qualitatively, for example, by comparing the actually scanned pattern with a setpoint pattern. If too large a deviation is noted, a signal can be output, which indicates inadequate setting of a predefined energy of the particle beam.

Only one location detector 37 and one scan magnet 49 are shown in FIG. 3. However, a number of scan magnets may be used in a particle therapy system, these being able to divert the particle beam in different directions, for example in x direction and in y direction. Similarly, a number of detectors may also be used in a beam application apparatus, to capture the location of the particle beam in different directions and/or in a redundant manner.

FIG. 4 shows an exemplary embodiment, which include a feedback control loop 51. If in regular operating mode, the particle beam is scanned over a target volume 45 using the feedback control loop 51, small deviations of the actual position of the particle beam from a setpoint position are compensated for. The location of the particle beam may be measured using the location detector 37 after diversion by the scan magnet 49 and the actual value is compared with a setpoint value. The feedback control loop 51 activates the scan magnet 49 accordingly, to guide the particle beam to the desired setpoint position.

The location detector(s) 37, which is/are incorporated in the feedback control loop 51, may verify the energy of the particle beam. During verification of the energy of the particle beam, however, the feedback control loop 51 is not used. The deviation of the location of the particle beam is then used specifically to verify the energy of the particle beam.

Alternatively, the feedback control loop may be used during irradiation and correction data determined in the feedback control loop used to conclude the energy of the particle beam. The location may not be used directly as a measure of the energy, rather the correct energy setting is concluded from the necessary correction of the location of the particle beam.

The embodiments according to FIG. 1 to FIG. 4 may be combined. For example, a deflection of the particle beam can be effected both at deflection magnets, which are used to divert the particle beam into a specific irradiation room, and at scan magnets, which are used to scan the particle beam over a target volume. The particle beam may be deflected with the beam guide in a gantry 21. Combinations of position measurement, e.g. a position measurement in the BAMS and a position measurement at the isocenter, can also be used.

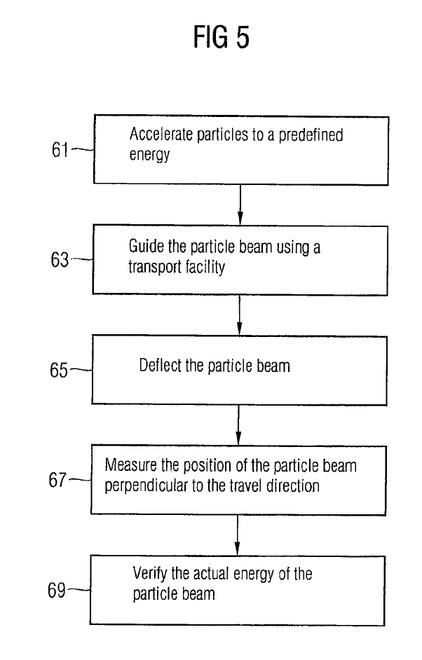

FIG. 5 shows one embodiment of a method.

In act 61, the charged particles are accelerated to a predefined energy. After the particles have been accelerated, the particles are guided along a transport apparatus, as shown in act 63, and deflected with a magnet, as shown in act 65. After the particle beam has been deflected, the position of the particle beam is measured in a direction or plane perpendicular to the travel direction of the particle beam, as shown in act 67. The measured position of the particle beam is used to verify the actual energy of the particle beam, for example, with respect to a deviation from the predefined energy, as shown in act 69. Acts 67 and 69 can be executed repeatedly, with the particle beam being deflected in a different manner with each repetition, so that the particle beam is directed onto other points in the room.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for verifying the energy of a particle beam in a particle therapy system, the method comprising:
accelerating charged particles to a predefined energy in an acceleration apparatus of the particle therapy system,
forming a particle beam from the charged particles and guiding the particle beam to an irradiation room of the particle therapy system using a transport apparatus,
deflecting the particle beam using at least one magnet,
measuring a position of the particle beam in a direction having a component perpendicular to the beam direction, and
verifying an actual energy of the particle beam using the measured position.

2. The method as claimed in claim 1, further comprising verifying the actual energy of the particle beam with respect to a deviation from the predefined energy of the particle beam.

3. The method as claimed in claim 1, further comprising aligning the particle isocentrically in the irradiation room having an isocenter.

4. The method as claimed in claim 1, further comprising:
controlling the particle beam in such a manner that the particle beam is diverted successively to different degrees,
measuring the position of the particle beam with each diversion, and
verifying the actual energy of the particle beam using the measured positions, in particular using a relative position of the measured positions.

5. The method as claimed in claim 1, wherein a measuring apparatus is used for position measurement.

6. The method as claimed in claim 5, further comprising:
accelerating the particles in the particle therapy system,
guiding, using the transport apparatus, the particle beam into the irradiation room, the particle beam exiting the transport apparatus from an exit window,
the measuring apparatus being disposed after the exit window in the beam direction.

7. The method as claimed in claim 5, wherein the measuring apparatus is disposed between the magnet and the exit window.

8. The method as claimed in claim 6, wherein the measuring apparatus is incorporated in a control mechanism for correction of the location of the particle beam, and
wherein the system is operated during implementation of the method in such a manner that the control mechanism for location correction is deactivated.

9. The method as claimed in claim 6, wherein the measuring apparatus is incorporated in a control mechanism for correction of the location of the particle beam, and
wherein the system is operated during implementation of the method in such a manner that correction data for the location correction, which is determined in the control mechanism, is used for energy verification.

10. An apparatus for verifying the energy of a particle beam, which is accelerated to a predefined energy and is guided by a transport apparatus and deflected from a straight travel direction, the apparatus comprising:
a measuring apparatus for measuring a position of the particle beam in a direction, which has a component perpendicular to the beam direction,
an evaluation apparatus for verifying an actual energy of the particle beam using the position measured by the measuring apparatus.

11. A system for accelerating charged particles, the system comprising:
an acceleration apparatus for accelerating charged particles to a predefined energy,
a transport apparatus for guiding the accelerated particle beam to an irradiation room,
a magnet for deflecting the particle beam, and
an energy verification apparatus with a measuring apparatus for measuring a position of the particle beam in a direction, which has a component perpendicular to the beam direction, and with an evaluation apparatus for verifying an actual energy of the particle beam using the position measured by the measuring apparatus.

12. The system as claimed in claim 1, wherein the energy verification apparatus being operable to verify the actual energy of the particle beam with respect to a deviation from the predefined energy of the particle beam.

13. The method as claimed in claim 1, wherein the energy verification apparatus is operable to align the particle isocentrically around an isocenter.

14. The method as claimed in claim 11, the energy verification apparatus is operable to: control the particle beam in such a manner that the particle beam is diverted successively to different degrees,
measure the position of the particle beam with each diversion, and
verify the actual energy of the particle beam using the measured positions, in particular using a relative position of the measured positions.

15. The method as claimed in claim 11, wherein the transport apparatus includes an exit window that allows the particle beam to exit the transport apparatus and enter the irradiation room and the measuring apparatus is disposed after the exit window in the beam direction.

16. The method as claimed in claim 11, wherein the measuring apparatus is disposed between the magnet and the exit window and is incorporated in a control mechanism for correction of the location of the particle beam, and wherein the system is operated during implementation of the method in such a manner that the control mechanism for location correction is deactivated.

17. The method as claimed in claim 4, wherein verifying includes verifying the actual energy of the particle beam using a relative position of the measured positions.

18. The method as claimed in claim 5, wherein the measuring apparatus is a wire chamber or strip chamber.
